(19) United States
(12) Patent Application Publication
(10) Pub. No.: US 2026/0131845 A1
(43) Pub. Date: May 14, 2026

(54) STEERING DEVICE FOR A VEHICLE

(71) Applicant: Renesas Electronics America Inc., Milpitas, CA (US)

(72) Inventors: Benjamin GALLAIS, Dusseldorf (DE); Andre PEREIRA, Dusseldorf (DE); Dinesh Kumar APOORVA, Dusseldorf (DE)

(73) Assignee: Renesas Electronics America Inc., Milpitas, CA (US)

(21) Appl. No.: 19/387,072

(22) Filed: Nov. 12, 2025

(30) Foreign Application Priority Data
Nov. 11, 2024 (GB) 2416577.1

(51) Int. Cl. B62D 1/04

(52) U.S. Cl. CPC B62D 1/046

(57) ABSTRACT

A steering device for a vehicle. The device includes one or more sensors configured to detect a plurality of hand motions from an operator of the vehicle and one or more circuits coupled to the one or more sensors. The one or more circuits are configured to adjust one or more elements of the vehicle based on a hand motion detected such that the operator of the vehicle can adjust the operation of the vehicle.

### FIELD

The present disclosure relates to a steering device for a vehicle, in particular but without limitation to a steering wheel comprising one or more sensors to allow an operator of the vehicle to adjust the operation of the car without removing one or more of their hands.

### BACKGROUND

In vehicles, there may be a number of dials, buttons or switches which enable the operator of the vehicle to perform a variety of functions. These dials, buttons and switches form part of what is known as the Human/Machine Interface (HMI). For example, if the vehicle is a car, then the functions that can be controlled via the HMI may include adjusting air-conditioning, heating, adjusting the volume of music, setting the drive mode of the car or activating alarm indicators to warn other drivers of an issue.

Typically, HMI elements are mechanical. More recently, capacitive switches have been used. However, both mechanical HMI elements and capacitive switches require the operator of the vehicle to move their hands from the device used to steer the vehicle (for example, a steering wheel if the vehicle is a car). This can result in the vehicle operator having a reduced attention span or affect their ability to use the steering device.

To overcome this, incorporation of some HMI elements onto the steering device has occurred. For example, the window control or volume control in a car may be incorporated into the steering wheel. However, incorporating the HMI elements into the steering device like this increases the complexity of the device. Furthermore, when incorporated into the steering device, the HMI elements are only able to serve a single function. Therefore, a higher number of HMI elements may be required which is undesirable.

Therefore, a new way to implement HMI elements in a steering device for a vehicle is required which overcomes these problems.

### SUMMARY

According to a first aspect of the present disclosure, there is provided a steering device for a vehicle, the steering device comprising: one or more sensors configured to detect a plurality of hand motions from an operator of the vehicle; and one or more circuits coupled to the one or more sensors; wherein the one or more circuits are configured to adjust one or more elements of the vehicle based on the hand motion detected such that the operator of the vehicle can adjust the operation of the vehicle.

Optionally, the operator can adjust the operation of the vehicle without removing one or more of their hands from the steering device.

Optionally, wherein the one or more sensors comprise one or more conductive foils.

Optionally, further comprising one or more paddle shifters, the paddle shifters being disposed on a back left hand side and/or a back right hand side of the steering device.

Optionally, the one or more sensors are disposed on the one or more paddle shifters.

Optionally, the one or more sensors are disposed on a front side of the steering device.

Optionally, the one or more sensors are disposed on a back side of the steering device.

Optionally, the one or more sensors are disposed on a left hand side of the steering device.

Optionally, the one or more sensors are disposed on a right hand side of the steering device.

Optionally, the one or more sensors are disposed on a front side, a back side, a left hand side and a right hand side of the steering device.

Optionally, the one or more sensors are arranged such that they define a plurality of detection zones, each detection zone being connected to each of the one or more circuits to adjust one or more elements of the vehicle.

Optionally, the sensors comprise impedance sensors and/or torque sensors.

Optionally, the plurality of hand motions are a plurality of touch motions.

Optionally, the plurality of touch motions comprise detection of one or more fingers, a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands.

Optionally, each touch motion in the plurality of touch motions is associated with changing the operation of an element of the vehicle.

Optionally, the one or more circuits comprises an impedance measuring system.

Optionally, the one or more sensors each have an associated impedance such that when one or more of the one or more sensors detect one of the hand motions in the plurality of hand motions, the associated impedance changes.

Optionally, the impedance measuring system is configured to detect the change in the associated impedance and adjust the one or more elements of the vehicle based on the change in associated impedance.

Optionally, the change in the associated impedance comprises an increase or a decrease in the associated impedance.

Optionally, the one or more elements of the vehicle comprises at least one of indicator system, heating system, call system, volume adjustment, autonomous driving system, display system, navigation system and/or drive mode system.

Optionally, changing the operation of the vehicle comprises at least one of turning on and/or off one or more elements of the vehicle, starting or stopping one of the vehicle indicators, increasing or decreasing the temperature inside the vehicle, increasing or decreasing the temperature of the steering device, making, answering or rejecting a call, increasing or decreasing the volume of music or a call, muting music or a call, starting or ending autonomous driving, changing what is shown on a display in the vehicle, initiating a map navigation to a pre-determined destination and/or selecting a drive mode of the vehicle.

Optionally, the steering device is a steering wheel.

According to a second aspect of the present disclosure, there is provided a vehicle comprising the steering device of the first aspect.

Optionally, the vehicle is a car, a truck, a lorry and/or a van.

It will be appreciated that the vehicle of the second aspect may include providing and/or using features set out in the first aspect and can incorporate other features described herein.

### BRIEF DESCRIPTION OF THE DRAWINGS

The disclosure is described in further detail below by way of example only with reference to the accompanying drawings, in which:

FIG. 1(a) is a first example embodiment of a steering device according to the present disclosure;

FIG. 1(b) is a second example embodiment of a steering device according to the present disclosure; FIG. 1(c) is a third example embodiment of a steering device according to the present disclosure and FIG. 1(d) is a fourth example embodiment of a steering device according to the present disclosure;

FIG. 2 is a block diagram of a steering device according to the present disclosure;

FIG. 3 is a graph showing detection of a plurality of hand motions detected by the steering device of the present disclosure;

FIG. 4 is a block diagram of an exemplary circuit that can be used in the steering device of the present disclosure; and

FIG. 5 is a diagram of a vehicle comprising a steering device of the present disclosure.

### DETAILED DESCRIPTION

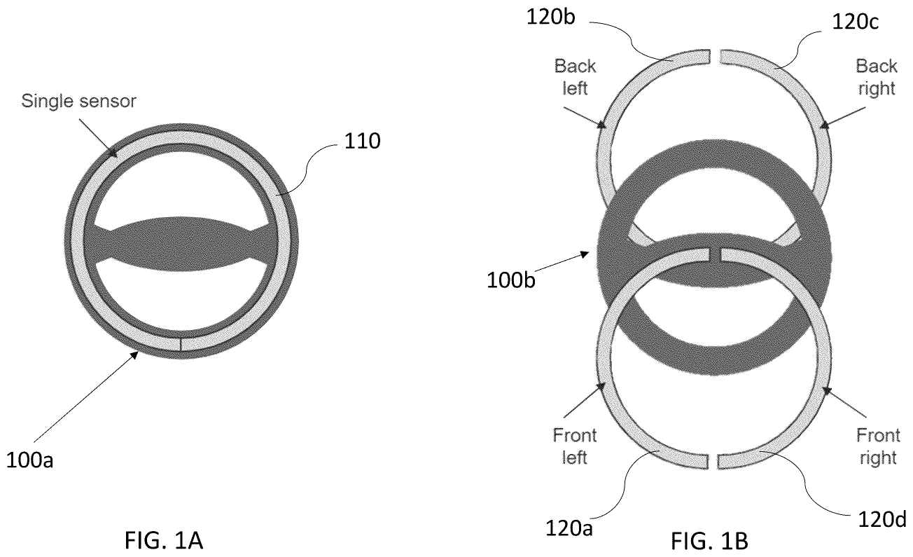

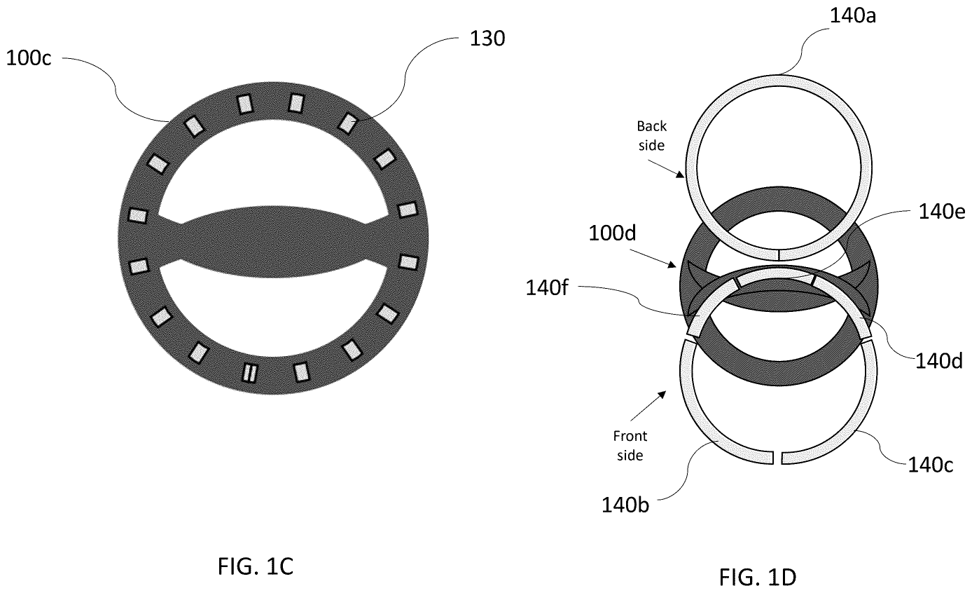

FIG. 1(a) shows a first example embodiment of a steering device 100a for a vehicle according to the present disclosure. The steering device 100a comprises a single sensor 110 which has been integrated into the steering device 100a. In further embodiments, more sensors may be integrated in accordance with the understanding of the skilled person. The steering device 100a further comprises one or more circuits (not shown) which are coupled to the sensor 110. The steering device 100a in this first example embodiment is a steering wheel 100a for a car, it will be appreciated that in further embodiments the steering device 100a may be implemented with other types of vehicles, in accordance with the understanding of the skilled person.

The sensor 110 is configured to detect a plurality of hand motions from an operator of the vehicle. Once a hand motion has been detected by the sensor 110, the one or more circuits are configured to adjust one or more elements of the vehicle based on the hand motion detected. In this way, an operator of the vehicle may adjust the operation of the vehicle without needing to remove one or more of their hands from the steering device. The hand motions are performed by either one or both hands of the operator and may include grabbing or swiping the steering wheel. The one or more elements of the vehicle may comprise the HMI elements that are known in the prior art, for example, the adjustment of the volume of music playing or the answering of a call.

The term adjust in the context of the present disclosure may to refer a number of actions including turning-on or turning-off one or more elements of the vehicle, activating or deactivating one or more elements of the vehicle, and increasing or decreasing one or more elements of the vehicle.

For example, in partially and fully autonomous vehicles, there is a need to assess whether the operator has their hands on the steering device. This may be for legal/regulatory reasons, in the case where the vehicle is partially autonomous (automation levels 2 and 3) or it may be to enable some sort of smooth transition from autonomous to manual driving (in the case where the operator decides to take control of the vehicle, touching the steering wheel may indicate a desire to deactivate autonomous driving). Therefore, to assess whether the operator has their hands on the steering wheel, the sensor 110 on the steering device 100 may be used. The sensors 110 can be positioned either on the left or right of the steering device 100a. The sensor 110 will measure a different impedance depending on whether the operator touches the steering device 100a or not and therefore the vehicle can use the sensor 110 to detect whether the operator has their hand or hands on the steering device 100c. This might also be referred to as Hands-ON/OFF detection. In other embodiments, the sensor 110 may be configured to detect different motions which will result in different changes to the operation of the vehicle in accordance with the understanding of the skilled person.

In the steering device 100a of FIG. 1(a), the single sensor 110 is integrated into a front side of the steering device 100b along its periphery. However, in other embodiments, the sensor 110 may be integrated into a back side, a left hand side or a right hand side of the steering device in accordance with the understanding of the skilled person. The sensor 110 may comprise an impedance sensor or a torque sensor. An impedance sensor is preferred as it can distinguish between the hand motion due to the operator's hand or hands and hand motion due to the addition of an object onto the steering device 100a. The sensor 110 is configured to detect whether an operator's hands are in contact with the steering device.

The circuit (not shown in FIG. 1(a)) comprises an impedance measuring system. The sensor 110 has an impedance associated with it. When the operator adds pressure to the sensor 110 with one or both of their hands, the associated impedance changes. The impedance measuring system is configured to detect this change in the impedance and adjust the one or more elements of the vehicle based on the change in the impedance. This change may be an increase or a decrease in the associated impedance.

In alternative embodiments, the steering device 100a may comprise two sensors 110 whereby the first sensor is integrated into a front side of the steering device and the second sensor is integrated into a back side of the steering device, in accordance with the understanding of the skilled person.

FIG. 1(b) shows a second example embodiment of an exploded view of a steering device 100b for a vehicle according to the present disclosure. The steering device 100b comprises four sensors 120a, 120b, 120c and 120d which have been integrated into the steering device 100b. The steering device 100b further comprises one or more circuits (not shown) which are coupled to each of the sensors 120a, 120b, 120c and 120d. The steering device 100b in this second example embodiment is a steering wheel 100b for a car, it will be appreciated that in further embodiments the steering device 100b may be implemented with other types of vehicles, in accordance with the understanding of the skilled person.

The sensors 120a, 120b, 120c and 120d are configured to detect a plurality of hand motions from an operator of the vehicle. Once a hand motion has been detected by one or more of the sensors 120a, 120b, 120c and 120d, the one or more circuits adjust one or more elements of the vehicle based on the hand motion detected. In this way, an operator of the vehicle may adjust the operation of the vehicle without needing to remove one or more of their hands from the steering device 100b. The plurality of hand motions may be, for example a plurality of touch motions that may be performed by one or both of the hands of the operator. The plurality of touch motions may include detection of one or more fingers, a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands.

The term adjust in the context of the present disclosure may to refer a number of actions including turning-on or turning-off one or more elements of the vehicle, activating or deactivating one or more elements of the vehicle, and increasing or decreasing one or more elements of the vehicle.

Each of the touch motions may be associated with changing the operation of a different element of the vehicle. For example, in one embodiment of the steering device 100b, an operator of the vehicle can set-up the vehicle such that if a call is incoming, double tapping on the front of the steering device 100b will accept the call, whilst double tapping on the back of the steering device 100b may reject the call (or vice versa). As another example, in another embodiment of the steering device 100b, during a call, tapping on the back of the steering device 100b may end the call. In yet another example, another embodiment of the steering device 100b double tapping on the front of the steering device 100b, when there is no call taking place, may lead to the navigation system being maximised in a display in the vehicle. Double tapping on the back of the steering device 100b may initiate a “navigate-to-home” function, whereby the navigation system automatically directs the operator to their home address, without the need for further interactions with the vehicle, and without the need to move the hands off the steering device 100b.

In the steering device 100b of FIG. 1(b), the sensors 120a, 120b, 120c and 120d are integrated into a front right hand side, a front left hand side, a back right hand side and a back left hand side of the steering device. Such an arrangement allows for four zones of detection across the steering wheel: left, right, front and back. The sensors 120a, 120b, 120d and 120c may comprise impedance sensors or torque sensors. Impedance sensors are preferred as they can distinguish between the pressure due to the operator's hand or hands and pressure due to the addition of an object to the steering device 100b. The sensors 120a, 120b, 120c and 120d are configured to detect one or more fingers, a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands.

In FIG. 1(b), there are two separate sensors 120a and 120d in the front and two further separate sensor 120b and 120c in the back of the steering device 100b. This allows for detection of whether specific predefined contacts, for example taps, has occurred on the left or the right of the steering device 100b. For example, in a given embodiment of the steering device 100b, the right side indicators of the vehicle may be activated by double tapping on the right side of the front (or back) of the steering device 100b. Thus, the detected gesture may be location specific. Furthermore, it may allow conditional touch-based input. For example, the vehicle may be configured to switch to fully autonomous driving if it detects (approximately concurrent) double tapping on both the left and right side of the steering device 100b, but may change the operation of a different element of the vehicle when the double tapping is only on the left or only on the right side of the steering device 100b.

Each of the one or more circuits (not shown in FIG. 1(b)) comprises an impedance measuring system. The sensors 120a, 120b, 120c and 120d each have an impedance associated with them. When the operator adds pressure to one or more of the sensors 120a, 120b, 120c and 120d, the impedance(s) associated with them changes. The impedance measuring system is configured to detect this change in the associated impedance(s) and adjust one or more elements of the vehicle based on the change in the associated impedance(s). This change may be an increase or a decrease in associated impedance.

FIG. 1(c) shows a third example embodiment of a steering device 100c for a vehicle according to the present disclosure. The steering device 100c comprises a plurality of sensors 130 integrated into the periphery of the steering device 100c. The steering device 100c further comprises one or more circuits (not shown) which are coupled to each of the sensors in the plurality of sensors 130. The steering device 100c in this third example embodiment is a steering wheel 100c for a car, it will be appreciated that in further embodiments, the steering device 100c may be implemented with other types of vehicles in accordance with the understanding of the skilled person.

The plurality of sensors 130 are configured to detect a plurality of hand motions from an operator of the vehicle. Once a hand motion has been detected by one or more sensors in the plurality of sensors 130, the one or more circuits adjust one or more elements of the vehicle based on the hand motion detected. In this way, an operator of the vehicle may adjust the operation of the vehicle without needing to remove one or both their hands from the steering device 100c. The arrangement of the plurality of sensors 130 define a plurality of detection zones. Each detection zone is connected to each of the one or more circuits to adjust one or more elements of the vehicle. The plurality of detection zones enables the capturing of more advanced gestures, such as swiping right or left (clockwise or counterclockwise). For example, in a given embodiment, the operator could activate the right indicator by swiping clockwise along the periphery of the steering wheel. The plurality of hand motions may be a plurality of touch motions which may also include detection of one or more fingers, a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands. Other hand motions and gestures may be accounted for in accordance with the understanding of the skilled person.

The term adjust in the context of the present disclosure may to refer a number of actions including turning-on or turning-off one or more elements of the vehicle, activating or deactivating one or more elements of the vehicle, and increasing or decreasing one or more elements of the vehicle.

The steering device 100c of the third example embodiment is preferred as it aids in distinguishing the plurality of hand motions. Each of the hand motions is associated with changing the operation of one element in the vehicle. For example, using three detection zones in a swipe to activate the right (or left) indicator is more robust than having just two detection zones for the same hand motion. In the same way, allocating three taps to pick up a call is more robust than just two taps.

In the steering device 100c of FIG. 1(c), the plurality of sensors 130 are integrated around the periphery of the front and back side of the steering device 100c allowing for multiple zones of detection. The plurality of sensors 130 may comprise impedance sensors or torque sensors. Impedance sensors are preferred as they can distinguish between the hand motion due to the operator's hands or hands and the hand motion due to the addition of an object to the steering device 100c. The plurality of sensors 130 are configured to detect one or more fingers, a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands. Other motions or hand gestures may be detected in accordance with the understanding of the skilled person.

Each of the one or more circuits (not shown in FIG. 1(c)) comprises an impedance measuring system. The plurality of sensors 130 each have an impedance associated with them. When the operator adds hand to one or more of the sensors in the plurality of sensors 130, the impedance(s) associated with the one or more sensors changes. The impedance measuring system is configured to detect this change in the associated impedance(s) and adjust one or more elements of the vehicle based on this change. The change may be an increase or a decrease in the associated impedance.

The arrangement one or more sensors integrated into the steering device defining one or more detection zones combined with the one or more circuits comprising an impedance measuring system enables fast (update rate of ≤0.5 ms per measurement configuration) and reliable gesture recognition, such as tap or swipe (one hand, two hands, full grab, one finger, two fingers, w/o gloves). The one or more circuits may comprise, for example, a sensor signal conditioner, but the steering device 100cs of the present disclosure is not limited to using this circuit.

FIG. 1(d) shows a fourth example embodiment of an exploded view of a steering device 100d for a vehicle according to the present disclosure. The steering device 100d comprises six sensors 140a, 140b, 140c, 140d, 140e and 140f which have been integrated into the steering device 100d. The steering device 100d further comprises one or more circuits (not shown) which are coupled to each of the sensors 140a, 140b, 140c, 140d, 140e and 140f. The steering device 100d in this fourth example embodiment is a steering wheel 100d for a car, it will be appreciated that in further embodiments the steering device 100d may be implemented with other types of vehicles, in accordance with the understanding of the skilled person.

The sensors 140a, 140b, 140c, 140d, 140e and 140f are configured to detect a plurality of hand motions from an operator of the vehicle. Once a hand motion has been detected by one or more of the sensors 140a, 140b, 140c, 140d, 140e and 140f, the one or more circuits adjust one or more elements of the vehicle based on the hand motion detected. In this way, an operator of the vehicle may adjust the operation of the vehicle without needing to remove one or more of their hands from the steering device 100d. The plurality of hand motions may be, for example, a plurality of touch motions that may be performed by one or both of the hands of the operator. The plurality of touch motions may include detection of one or more fingers, a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands.

The term adjust in the context of the present disclosure may to refer a number of actions including turning-on or turning-off one or more elements of the vehicle, activating or deactivating one or more elements of the vehicle, and increasing or decreasing one or more elements of the vehicle.

Each of the touch motions may be associated with changing the operation of a different element of the vehicle. For example, the in one embodiment of the steering device 100d, an operator of the vehicle can set-up the vehicle such that tapping one the steering device 100d with two fingers three times initiates a call to a pre-set person or number. Other example embodiments, as described for the steering devices 100a, 100b, 100c, may also be implemented with the steering device 100d of FIG. 1(d) in accordance with the understanding of the skilled person.

In the steering device 100d of FIG. 1(d), the sensors 140a, 140b, 140c, 140d, 140e and 140f are integrated into the front and back of the steering device 100d. The arrangement is as follows, the back of the steering device 100d comprises a single sensor 140a, whilst the front of the steering device comprises five sensors 140b, 140c, 140d, 140e and 140f. The sensors 140b, 140c, 140d, 140e and 140f are not all of the same size. The sensors 140d, 140e, 140f, disposed at the top at the front of the steering device are smaller than the sensors 140b, 140c located at the bottom-left and bottom-right of the front of the steering device 100d. This arrangement allows for six zones of detection across the steering device 100d. More advanced gestures may be captured at the top front of the steering device 100d which comprises three sensors 140d, 140e, 140f compared to the back of the steering device 100d which only comprises a single sensor 140a. Thus, the detected gestures may also be location specific. Furthermore, such an arrangement may allow for conditional touch-based input. For example, the vehicle may be configured to switch to fully autonomous driving if it detects (approximately concurrent) double tapping on both the left and right side of the steering device 100d, but may change the operation of a different element of the vehicle when the double tapping is only on the left or only on the right side of the steering device 100d.

Each of the one or more circuits (not shown in FIG. 1(d)) comprises an impedance measuring system. The sensors 140a, 140b, 140c, 140d, 140e and 140f each have an impedance associated with them. When the operator add pressure to one or more of the sensors 140a, 140b, 140c, 140d, 140e and 140f, the impedance(s) associated with them changes. The impedance measuring system is configured to detect this change in the associated impedance(s) and adjust one or more elements of the vehicle based on the change in the associated impedance(s). This change may be an increase or a decrease in the associated impedance.

The steering devices of the present disclosure may work independently of any environmental variations, for example temperature and/or humidity.

The steering device of the present disclosure may be configured to change the operation of a number of different functions and elements of the vehicle. For example, Hands On and Hands Off detection on the steering device, by recognition of full grab from both hands on both the right and left side of the steering device. Other examples include: activation of the blinker function, by swiping from right to left and from left to right on the top of the steering device; activating or deactivating the steering device heating system by grabbing the left hand side of the steering device and apply three taps to the front, right side of the steering device; picking up or hanging up a call by either grabbing the right side of the steering device or tapping the front left side of the steering device three times; increasing or decreasing the volume of the conversation/music using three taps on the top right side and top left side of the steering device; muting or unmuting the conversation/music using three taps on the top middle part of the steering device; having two levels of threshold set for the back sensor based on one hand touch and two hands touch.

Any of the steering devices 100a, 100b, 100c may further comprise one or more paddle shifters situated on the back left-side and/or back right-side of the steering device whereby the one or more sensors may be disposed on the paddle shifters as well as the steering device itself.

In any of the steering devices 100a, 100b, 100c, 100d, the impedance of the one or more sensors can be changed through a plurality of hand motions two or more times in a pre-determined timeout period. For example, for a given sensor, the operator may tap the sensor multiple times to adjust one element of the vehicle and then, within the pre-determined timeout period, also swipe the sensor to adjust a different element. The pre-determined timeout period may be, for example, 5 seconds, but in other embodiments in can be shorter or longer in accordance with the understanding of the skilled person.

In the most preferred embodiment, the plurality of hand motions are performed on the steering device 100a, 100b, 100c, 100d by one hand whilst the other hand continually grabs the wheel. The grabbing of the wheel by the other hand does not interfere with the hand motions performed by the first hand.

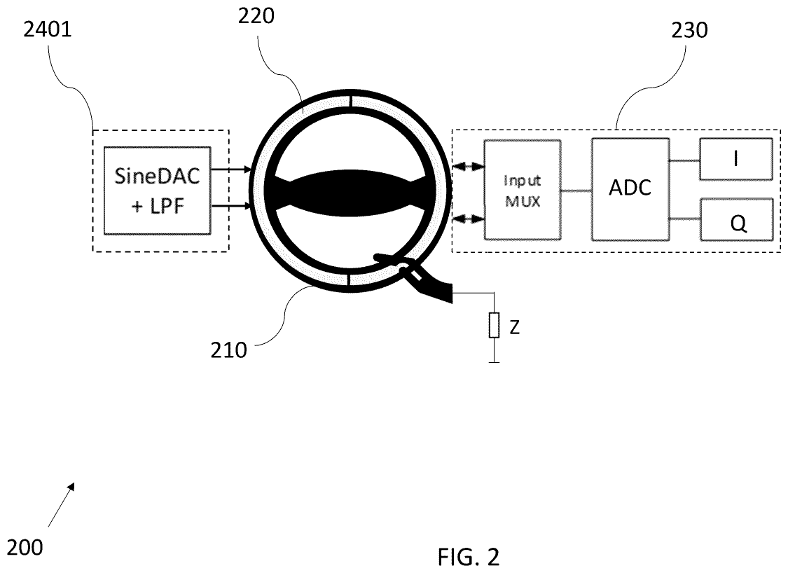

FIG. 2 is a block diagram 200 of a steering device 210 in accordance with the present disclosure. The steering device 210 comprises one or more sensors 220 and may be any of the steering devices 100a, 100b or 100c as previously described. The steering device 210 may be, for example, a steering wheel for a car. In other embodiments, the steering device 210 may be integrated with other types of vehicles in accordance with the understanding of the skilled person.

In the example embodiment of the steering device 210 the one or more sensors are one or more conductive foils (not shown). Each of the conductive foils are driven by a sine wave signal generated by the integrated circuit 240. The front end 230 is configured to measure the voltage drop due to the load impedance and derives the in-phase and quadrature phase components of it based on the amplitude and phase-shift change.

In operation, the pressure motion asserted by an operators hands causes the ground capacity across the conductive foil to increase thus adding impedance Z to the sensors 220.

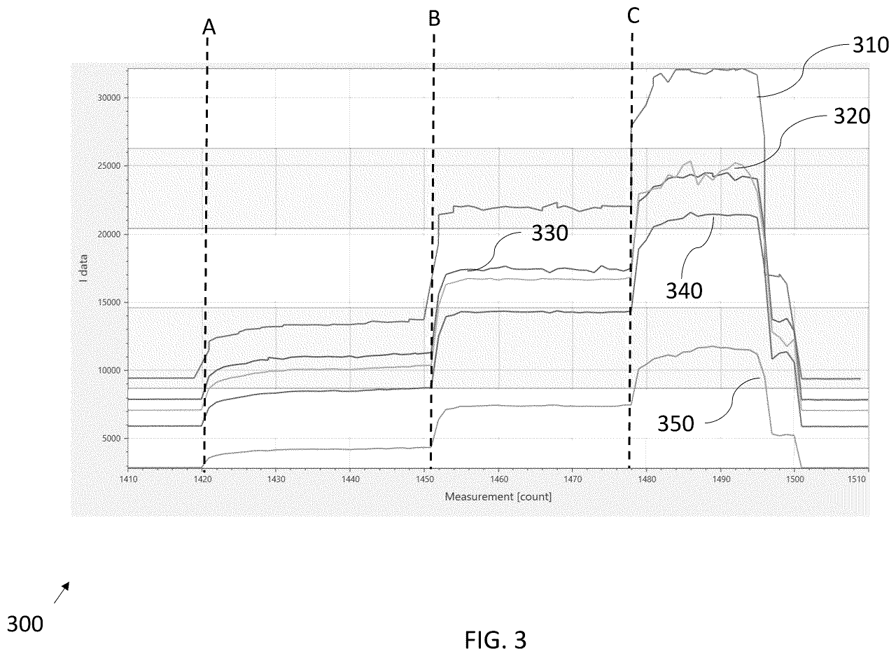

FIG. 3 is a graph 300 showing the detection of a plurality of hand motions that may be detected by any of the steering devices of the present disclosure. The graph shows five different steering device setups 310, 320, 330, 340 and 350 and their detection reaction to a tap with a single finger (A), a tap with two fingers (B) and a full hand grab (C). The y-axis of graph 300 displays the LSB counts of in-phase component of the signals. The increases in amplitude at each detection reaction signifies a change in the impedance across the sensors.

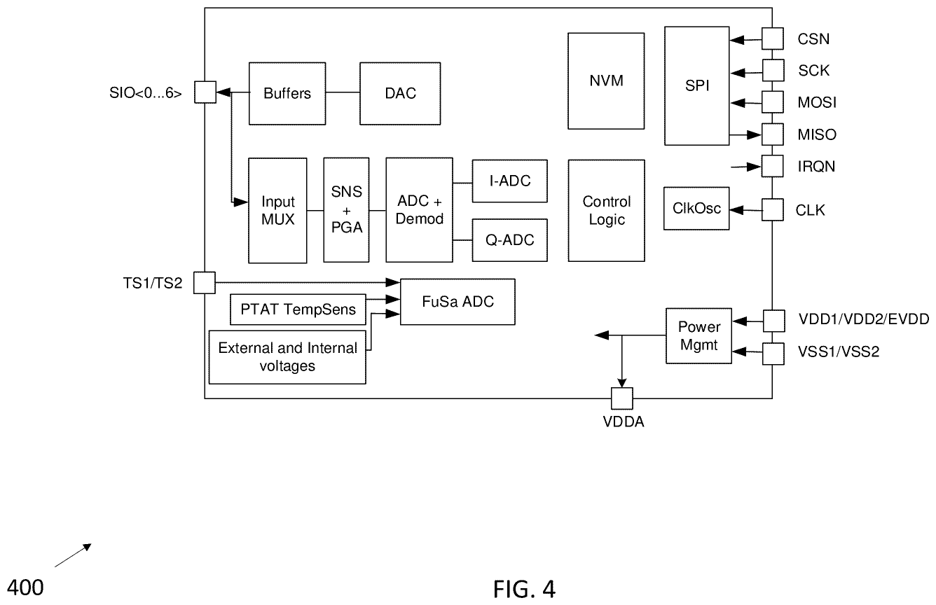

FIG. 4 is a block diagram of an exemplary circuit 400 that can be used in any of the steering devices of the present disclosure. In this particular example, the circuit 400 is an impedance measurement interface integrated circuit (IC) for up to 7 channels, it comprises a wide set of self-supervision and sensor diagnostic features.

The circuit 400 can be configured to sixteen different setups which have configurable gain, non-harmonic frequencies, demodulation phase shift. The circuit has sensitivity up to 3.3 fF/LSB, high accuracy±1.5% FS and a fast measurement rate.

In order to measure an external impedance (DUT), the circuit 400 has to generate measurement values representing the amplitude and phase (or in-phase and quadrature phase of the DUT signal. To reduce the number of signal pins only one connection per DUT should be used providing a “test-signal”. In order to measure both the in-phase and quadrature-phase parts of a complex DUT signal, the test-signal must be a time variant signal, for example a Signal-Pulse or Sine Wave.

By applying a sine signal (voltage) to a DUT, can measure the amplitude and phase of the current running through the DUT. Alternatively, can apply a current to the DUT and measure the voltage across it. The amplitude and phase is measured by demodulation the test signal (either the current through DUT or voltage across DUT) and multiplying the signal with a SIN and COS signal at same frequency. Output (after filtering) is an in-phase and quadrature-signal at DC. Amplitude is sqrt((in-phase)²+(quadrature phase)²), Phase is arctan ((quadrature phase)/(in-phase)).

The demodulation (ADC+Demod) is realized in digital domain after an ADC, thus matching between SIN/COS is given per construction. The multiplication with SIN/COS takes place at same time with same signal, using only one acquisition per result. The ADC is an over-sampling ADC, in this exemplary embodiment, a sigma-delta ADC may be used (for example, a 1-Bit, 2^{nd} order sigma delta).

The used test-signal and the SIN/COS for the demodulation are based on the same digital signal (e.g. lookup tables), so the phase difference is constant and independent of analog matching between the three signals (test-signal-SIN-COS).

The frequency of the test-signal is coherent with demodulation signal (SIN/COS) and the number of signal periods is a prime number of the sampled signal. Therefore, all harmonics of the demodulated signals will be completely filtered out by the digital filter. The result is a comb filter with notches at all the harmonics. Additionally, the SIN/COS (digital) signals requires a low number of samples per period which reduces the effort for the associated lookup-table. The lower number of samples causes increased harmonics, but system in insensitive to harmonics due to the comb filter. For the test signal generation with a DAC, the sampling rate of the DAC can be reduced meaning the circuit is less sensitive to harmonics.

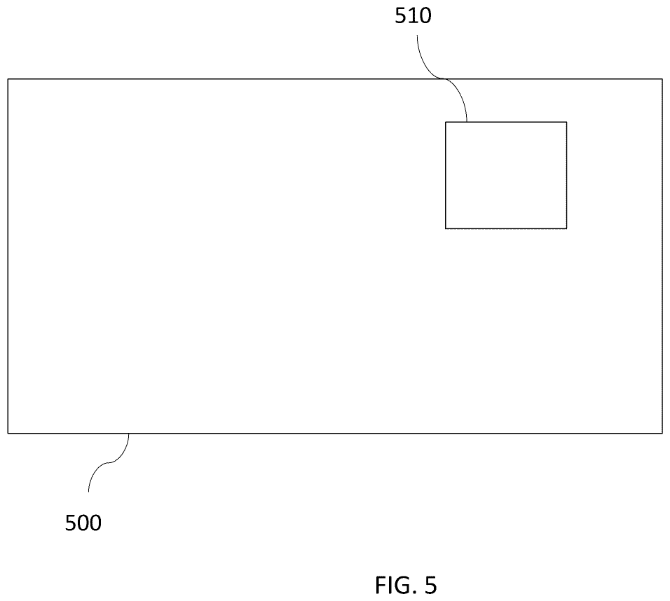

FIG. 5 is a diagram of a vehicle 500 comprising a steering device 510. The steering device 510 may be any of the steering devices described herein. The vehicle 500 may be a car, a truck, a lorry and/or a van.

The steering device 510 is configured to detect one or more of the following hand motions: a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands.

Each of these hand motions may change the operation of one or more elements of the vehicle. The one or more elements may comprise the indicator system, the heating system, the call system, the volume adjustment, the autonomous driving system, the display system, the navigation system and/or the drive mode system. By changing the operation of one or more of these elements means either:
starting or stopping one of the vehicle indicators;
increasing or decreasing the temperature inside the vehicle;
increasing or decreasing the temperature of the steering device;
making, answering or rejecting a call, increasing or decreasing the volume of music or a call;
muting music or a call;
starting or ending autonomous driving;
changing what is shown on a display in the vehicle;
initiating a map navigation to a pre-determined destination; and/or
selecting a drive mode of the vehicle.

It will be appreciated that the steering device of the present disclosure may be a steering wheel for a vehicle. Further embodiments may relate to a steering wheel for a truck, van, boat or a steering handle for a motorbike, in accordance with the understanding of the skilled person.

A skilled person will appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A steering device for a vehicle, the steering device comprising:
one or more sensors configured to detect a plurality of hand motions from an operator of the vehicle; and
one or more circuits coupled to the one or more sensors;
wherein the one or more circuits are configured to adjust one or more elements of the vehicle based on a hand motion detected such that the operator of the vehicle can adjust the operation of the vehicle.

2. The steering device of claim 1, wherein the operator can adjust the operation of the vehicle without removing one or more of their hands from the steering device.

3. The steering device of claim 1 wherein the one or more sensors comprise one or more conductive foils.

4. The steering device of claim 1 further comprising one or more paddle shifters, the paddle shifters being disposed on a back left hand side and/or a back right hand side of the steering device.

5. The steering device of claim 4, wherein the one or more sensors are disposed on the one or more paddle shifters.

6. The steering device of claim 1, wherein the one or more sensors are disposed on a front side of the steering device.

7. The steering device of claim 1, wherein the one or more sensors are disposed on a back side of the steering device.

8. The steering device of claim 1, wherein the one or more sensors are disposed on a left hand side of the steering device.

9. The steering device of claim 1, wherein the one or more sensors are disposed on a right hand side of the steering device.

10. The steering device of claim 1, wherein the one or more sensors are disposed on a front side, a back side, a left hand side and a right hand side of the steering device.

11. The steering device of claim 1, wherein the one or more sensors are arranged such that they define a plurality of detection zones, each detection zone being connected to each of the one or more circuits to adjust one or more elements of the vehicle.

12. The steering device of claim 11, wherein the sensors comprise impedance sensors and/or torque sensors.

13. The steering device of claim 1, wherein the plurality of hand motions are a plurality of touch motions.

14. The steering device of claim 13, wherein the plurality of touch motions comprise detection of one or more fingers, a grab of one hand, a grab of two hands, a release of one hand, a release of two hands, a swiping motion from left to right, a swiping motion from right to left, a single tap of one hand, two or more taps of one hand, a single tap of two hands, and/or two or more taps of two hands.

15. The steering device of claim 14, wherein each touch motion in the plurality of touch motions is associated with changing the operation of an element of the vehicle.

16. The steering device of claim 1, wherein the one or more circuits comprises an impedance measuring system.

17. The steering device of claim 16, wherein the one or more sensors each have an associated impedance such that when one or more of the one or more sensors detect one of the hand motions in the plurality of hand motions, the associated impedance changes.

18. The steering device of claim 17, wherein the impedance measuring system is configured to detect the change in the associated impedance and adjust the one or more elements of the vehicle based on the change in associated impedance.

19. The steering device of claim 18, wherein the change in the associated impedance comprises an increase or a decrease in the associated impedance.

20. The steering device of claim 1, wherein the one or more elements of the vehicle comprises at least one of indicator system, heating system, call system, volume adjustment, autonomous driving system, display system, navigation system and/or drive mode system.

21. The steering device of claim 20, wherein changing the operation of the vehicle comprises at least one of turning on and/or off one or more elements of the vehicle, starting or stopping one of the vehicle indicators, increasing or decreasing the temperature inside the vehicle, increasing or decreasing the temperature of the steering device, making, answering or rejecting a call, increasing or decreasing the volume of music or a call, muting music or a call, starting or ending autonomous driving, changing what is shown on a display in the vehicle, initiating a map navigation to a pre-determined destination and/or selecting a drive mode of the vehicle.

22. The steering device of claim 1, wherein the steering device is a steering wheel.

23. A vehicle comprising the steering device of claim 1.

24. The vehicle of claim 23, wherein the vehicle is a car, a truck, a lorry and/or a van.
